(19) United States
(12) Patent Application Publication
(10) Pub. No.: US 2005/0099982 A1
(43) Pub. Date: May 12, 2005

(54) Proxy device and method for controlling devices in a domain

(75) Inventors: Young-chul Sohn, Suwon-si (JP); Jung-yon Cho, Seoul (KR); Won-hee Lee, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/972,580

(22) Filed: Oct. 26, 2004

(30) Foreign Application Priority Data
Oct. 27, 2003 (KR) 03-75231

(51) Int. Cl. H04L 12/28

(52) U.S. Cl. 370/338

(57) ABSTRACT

A method of remotely controlling universal plug and play (UPnP) devices in a domain system, the method comprising, (a) requesting list data of the devices in the domain system and storing the list data, and (b) generating a search response packet based on the list data stored in step (a), when a search for the devices is remotely requested, so that the UPnP devices in the domain can be effectively searched.

### CROSS REFERENCE TO RELATED APPLICATIONS

This application claims priority from Korean Patent Application No. 2003-75231, filed on Oct. 27, 2003, in the Korean Intellectual Property Office, the disclosure of which is incorporated herein by reference in its entirety.

### BACKGROUND OF THE INVENTION

1. Field of the Invention

The present invention relates to a domain system, and more specifically, to a proxy device and a method for allowing universal plug and play (UPnP) devices in a domain system to be effectively searched from a remote location.

2. Description of the Related Art

In general, computer operating systems can more easily install or add peripheral devices to the computers by using a plug and play (PNP) function. A universal plug and play (UPnP) protocol is a middle-ware protocol capable of automatically searching for and controlling devices such as printers, internet gateways and information appliances connected to networks, and services provided by the devices.

A UPnP network comprises a UPnP controller (sometimes referred to as a control point) which serves as a controller capable of searching for and controlling other devices, UPnP devices which are targets to be controlled, and services which are the smallest units to be controlled. When such a UPnP network supports devices in a domain, a user can automatically search for the UPnP devices and use the services provided from the UPnP devices by using the UPnP controller.

UPnP was originally developed for domains, and provides mechanisms for guaranteeing interoperability between the devices in a sub-net. When a new UPnP device is connected to a domain, the new UPnP device informs the domain of its existence through a multicast channel. Similarly, when the UPnP controller is connected to the domain, the UPnP controller transmits a message for searching the UPnP devices connected to the domain through the multicast channel. The UPnP devices responding to the message are added to a device list of the UPnP controller, and thus a user can select and control a desired UPnP device.

However, when a user located outdoors wants to control UPnP devices located indoors, by using the UPnP controller, the UPnP controller typically cannot detect the indoor UPnP devices due to a restricted transfer range of a multicast packet. In general, only several routers can be used to transfer a multicast packet. Therefore, the UPnP controller in the UPnP network cannot detect any UPnP devices on the Internet that are beyond the transfer range of the multicast packet.

A conventional UPnP remote control technology for solving the above problem is disclosed in U.S. Patent Publication No. US 2003-0063698 A1 (U.S. patent application Ser. No. 09/970,539) to Jan Renier Moonen, published on Apr. 3, 2003 and entitled “MULTICAST DISCOVERY PROTOCOL USES TUNNELING OF UNICAST MESSAGE”.

The UPnP remote control system shown in FIG. 1 comprises a controller device (CD) proxy 107 and a control point (CP) proxy 108, which transmit multicast packets between a domain 102 and a domain 104, e.g., Home1 and Home2. First, the CD proxy 107 transmits a search request packet received by a UPnP controller 106 in its domain 102 to the CP proxy 108 in a counterpart domain 104 by using a tunneling technology. The CP proxy 108 transmits the search request packet to a UPnP device 109 in the counter domain 104 through a multicast channel.

Next; when the CP proxy 108 receives a search response packet from the UPnP device 109, the CP proxy 108 transmits the search response packet to the CD proxy 107 in the different domain 102 by using the tunneling technology. The CD proxy 107 transmits the search response packet to the UPnP controller 106 through the multicast channel.

When the CP proxy 108 receives an advertisement/byebye packet from the UPnP packet 109, the CP proxy 108 transmits the advertisement/byebye packet to the CD proxy 107 in the different domain 102. Then, the CD proxy 108 transmits the advertisement/byebye packet to the UPnP controller 106 through the multicast channel.

In the above-described conventional system, one proxy transmits all the search packets, such as the search request packet, the search response packet, the advertisement packet, the byebye packet, etc., received in the domain, to a counterpart proxy. However, these packets not only greatly increase the communication quantity according to the number of devices, but also a long time is required for receiving a response after the UPnP controller 106 transmits a search request packet to the UPnP device 109, depending upon the particular conditions of the network.

### SUMMARY OF THE INVENTION

The present invention provides a method for allowing a universal plug and play (UPnP) device in a domain to be effectively searched for from a remote location.

The present invention also provides a proxy device for allowing a UPnP device in a domain to be effectively searched for from a remote location.

The present invention also provides a domain system for allowing a UPnP device in a domain to be effectively searched for from a remote location.

According to one exemplary embodiment of the present invention, there is provided a method of remotely controlling universal plug and play (UPnP) devices in a domain, the method comprising, (a) requesting list data of the UPnP devices in the domain and storing the received list data and (b) generating a search response packet on the basis of the list data stored in step (a), when a search for the UPnP devices is remotely requested.

According to another exemplary embodiment of the present invention, there is provided a proxy device for remotely controlling universal plug and play (UPnP) devices in a domain, the proxy device comprising a device list unit which stores a list of the UPnP devices; a list management unit which requests the list of the UPnP devices in the domain and stores the list in the device list unit; and a UPnP processing unit which generates a search response packet corresponding to the UPnP devices stored in the device list unit when a search for the UPnP devices is remotely requested.

According to still another embodiment of the present invention, there is provided a domain system in which a remote UPnP controller controls universal plug and play (UPnP) devices in a domain, the system comprising control point (CP) proxy means which transmits a UPnP packet received from a UPnP device through the Internet and transmits a received UPnP packet to the UPnP device and controlled device (CD) proxy means which transmits the UPnP packet received from the UPnP controller to the CP proxy means and transmits the UPnP packet received from the CP proxy means to the UPnP controller, wherein the CD proxy means stores a UPnP device list received in response to requesting the CP proxy means for the UPnP device list, and when a search for the devices is requested from the remote UPnP controller, searches the UPnP device list and generates a response packet.

### BRIEF DESCRIPTION OF THE DRAWINGS

The above and other features and advantages of the present invention will become more apparent from detailed description of exemplary embodiments thereof with reference to the attached drawings in which:

FIG. 1 is a diagram illustrating an example of a conventional method of controlling devices in a domain;

FIG. 2 is a block diagram illustrating a remote control system according to the present invention;

FIG. 3 is a block diagram illustrating in detail a controlled device (CD) proxy shown in FIG. 2;

FIG. 4 is a block diagram illustrating a universal plug and play (UPnP) processing unit as shown in FIG. 3; and

FIG. 5 is a diagram illustrating an embodiment of a method of controlling devices in a domain according to the present invention.

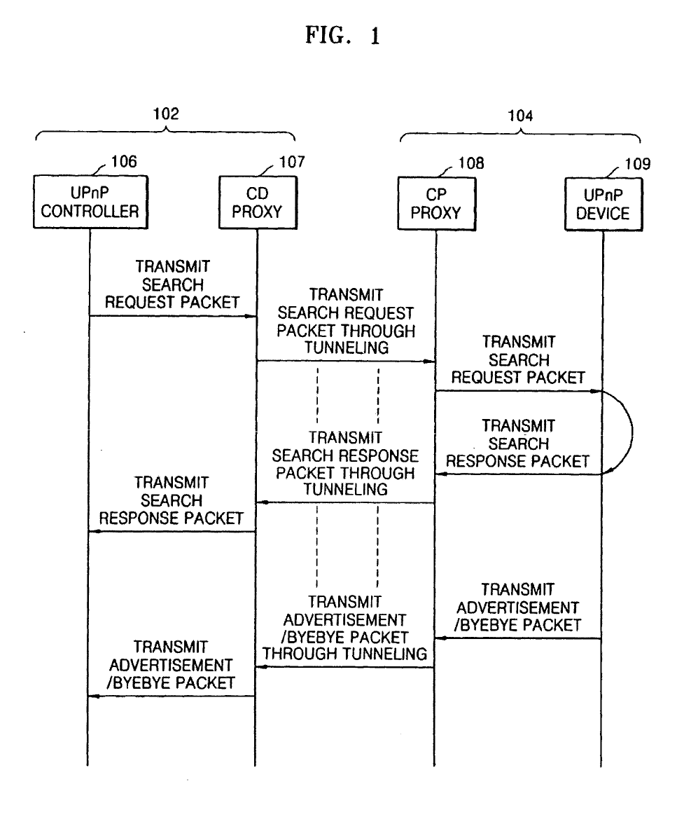

### DETAILED DESCRIPTION OF THE INVENTION

The present invention and operational advantages thereof can be fully understood by referring to the attached drawings and explanations thereof.

Now, exemplary embodiments of the present invention will be described in detail with reference to the attached drawings. In the drawings, the same reference numerals indicate the same elements.

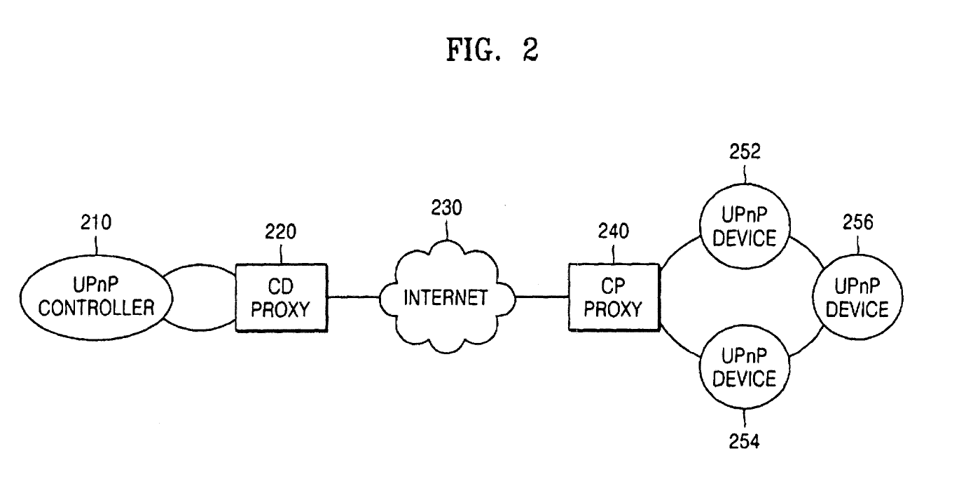

FIG. 2 is a block diagram illustrating a remote control system according to the present invention.

In FIG. 2, a universal plug and play (UPnP) controller 210 and UPnP devices 252, 254, 256 have internet protocol (IP) addresses for accessing them through the Internet 230.

A controlled device (CD) proxy 220 receives multicast packet data generated by the UPnP devices 252, 254, and 256 from a control point (CP) proxy 240, and transmits the data to the UPnP controller 210 through the multicast channel. Specifically, the CD proxy 220 includes a UPnP device list, and when it receives a search request packet from the UPnP controller 210, it searches the UPnP device list and generates a search response packet.

The CP proxy 240 receives a list request packet from the outdoor CD proxy 220, and transmits the list request packet to the UPnP devices 252, 254, and 256 through the multicast channel. Also, the CP proxy 240 receives response packets to the list request packet from the UPnP devices 252, 254, and 256, and transmits the response packets to the CD proxy 220.

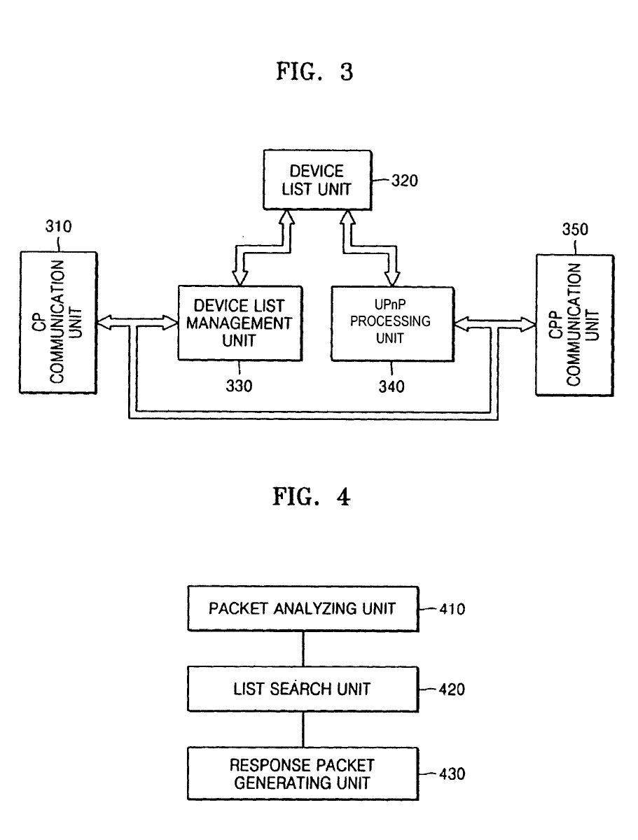

FIG. 3 is a block diagram illustrating in detail the CD proxy 220 shown in FIG. 2.

Referring to FIG. 3, a CP communication unit 310 receives a search request packet from the UPnP controller 210, and transmits a search response packet.

A control point proxy (CPP) communication unit 350 receives the list data from the CP proxy 240 by using the list request packet and the list response packet.

A device list unit 320 stores the list data on the UPnP devices 252, 254, and 256 received through the CPP communication unit 350. The list data may include present operational data and functional data on a refrigerator, a television, an air-conditioner, etc.

A device list management unit 330 requests the list data on the UPnP devices 252, 254, and 256 in a domain, and stores the list data in the device list unit 320.

A UPnP processing unit 340 generates the search response packet based on the list data stored in the device list unit 320, when receiving the search request packet from the remote UPnP controller 210.

FIG. 4 is a block diagram illustrating the UPnP processing unit 340 shown in FIG. 3.

A packet analyzing unit 410 analyzes the received search request packet to search the UPnP devices 252, 254, and 256.

A list search unit 420 searches the device list corresponding to the UPnP devices 252, 254, and 256 analyzed by the packet analyzing unit 410.

A response packet generating unit 430 generates the search response packet based on the device list data searched by the list search unit 420.

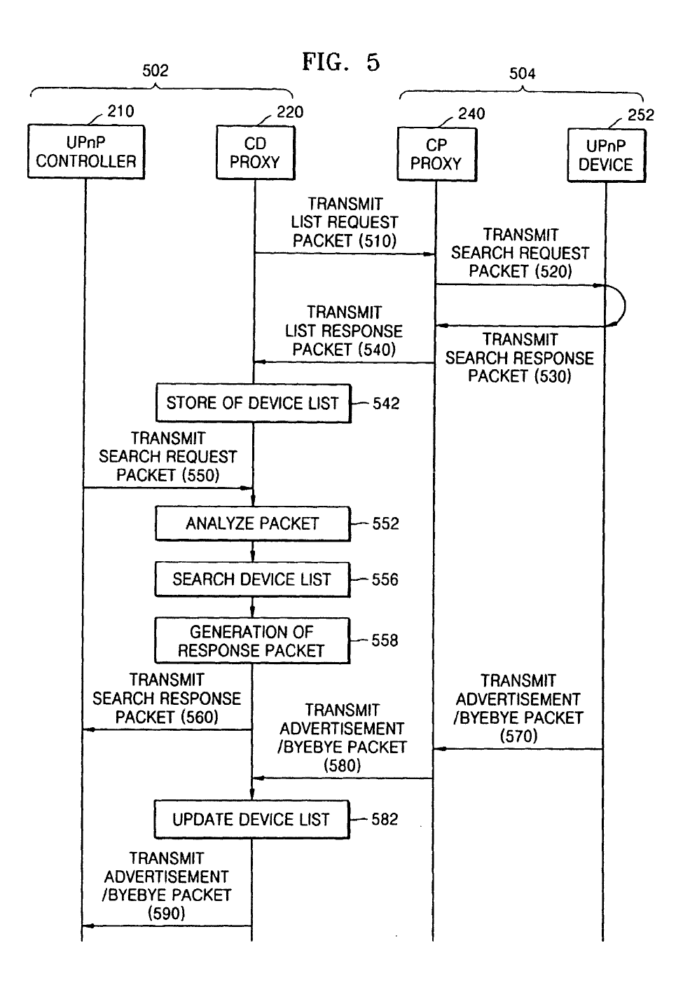

FIG. 5 is a diagram illustrating a method of controlling the domain devices according to the present invention.

A domain system comprises the CD proxy 220 and the CP proxy 240, which transmit the multicast packets between a domain 502 and a domain 504, e.g., Home 1 and Home 2.

The CD proxy 220 transmits a list request packet to the CP proxy 240 through the Internet (step 510). Here, the list request packet is used to request a list of the overall UPnP devices 252, 254 (not shown), and 256 (not shown) in a domain 504. Then, the CP proxy 240 transmits a search request packet to the UPnP devices 252, 254, and 256 through the multicast channel (step 520).

A search target (ST) field included in the search request packet is set to “ssdp:all” so as to find out the UPnP devices. An example of the search request packet is as follows:
M-SEARCH*HTTP/1.1
HOST: 239.255.255.250:1900
MAN: “ssdp:discover”
MX: 5
ST: ssdp:all
CONTENT-LENGTH: 0

Next, the UPnP devices 252, 254, and 256 transmit the search response packets 530 to the CP proxy 240 (step 530). A location field included in the search response packet indicates a device description uniform resource locator (URL) for accessing the device. Then, the CP proxy 240 collects several search response packets from the UPnP devices 252, 254, and 256 and transmits them to the CD proxy 220 through the Internet (step 540).

The CD proxy 220 receives the search response packets from the CP proxy 240, and stores the list data of the UPnP devices 252, 254, and 256 (step 542).

The CD proxy 220 receives the search request packet from the UPnP controller 210 through the multicast channel (step 550).

When the CD proxy 220 receives the search request packet from the UPnP controller 210, the CD proxy 220 analyzes the ST field of the packet (step 552), searches the device list (step 556), prepares a list of devices requested by the UPnP controller 210, generates a search response packet from the prepared list (step 558), and then transmits the search response packet to the UPnP controller 210 (step 560). The UPnP controller 210 discovers the desired UPnP devices from the search response packet, and acquires the device description URLs for accessing the devices.

On the other hand, when a new UPnP device is added to or removed from the domain, the new UPnP device transmits an advertisement/byebye packet indicating its own operational condition to the CP proxy 240 (step 570).

When the CP proxy 240 receives the advertisement/byebye packet from the new UPnP device, the CP proxy 240 transmits the advertisement/byebye packet to the CD proxy 220 in the counterpart domain 502 through the Internet (step 580). Then, the CD proxy 220 updates the device list on the basis of the advertisement/byebye packet (582), and then transmits the advertisement/byebye packet to the UPnP controller 210 through the multicast channel (step 590). If the UPnP device 252 transmits the advertisement packet indicating a new addition to the domain, the UPnP controller 210 can access the new UPnP device 252 by using the device description URL included in the packet.

The CD proxy 220 requests transmission of the advertisement/byebye conditions of the UPnP devices to the CP proxy 240 at a proper time interval so as to reflect the advertisement/byebye conditions of the UPnP devices 252, 254, and 256 in the domain 504 into the device list. The time interval can be varied depending upon a condition of the communication network between the CD proxy 220 and the CP proxy 240 and the conditions of the communication networks in the respective domains.

In another exemplary embodiment, when the CD proxy 220 is provided in a PDA and the PDA is powered off, the transmitted advertisement/byebye packet is not reflected in the device list. When the PDA is powered on again, the CD proxy 220 newly transmits the search request packet to the CP proxy 240, and updates the device list.

Therefore, the CD proxy 220 can generate the search response packet without the help of the CP proxy 240, when several UPnP controllers transmit the search request packets.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, conventionally, when several UPnP controllers transmit search request packets, a large amount of communication is required between the CD proxy and the CP proxy. However, according to the present invention, after the device list is once acquired, the search response packet can be generated by using the device list stored in the CD proxy 220, so that it is possible to reduce the amount of communication between the CD proxy 220 and the CP proxy 240, thus, reducing a response time to the search request.

While the present invention has been particularly shown and described with reference to exemplary embodiments thereof, it will be understood by those skilled in the art that various changes in form and details may be made therein without departing from the spirit and scope of the present invention as defined by the following claims.

1. A method of remotely controlling devices in a domain, the method comprising:
(a) requesting list data of the devices in the domain and storing the list data of the devices; and
(b) generating a search response packet based on the list data of the devices stored in step (a), when a search for the devices is remotely requested.

2. The method according to claim 1, wherein the devices have a UPnP format.

3. The method according to claim 1, further comprising: (a-1) when an advertisement/byebye packet is received in step (a), reflecting data of the advertisement/byebye packet in the list data of the devices.

4. The method according to claim 1, further comprising: (a-2) updating the device list data with reference to an advertisement/byebye packet, which is received in response to transmission of a search request packet when power is turned on in step (a).

5. The method according to claim 4, wherein the advertisement/byebye packet is received within a predetermined time interval.

6. The method according to claim 1, wherein step (b) comprises:
(b-1) analyzing a UPnP device on the basis of a received search request packet;
(b-2) searching the list data for the UPnP device analyzed in sub-step (b-1); and
(b-3) generating the search response packet on the basis of the list searched in sub-step (b-2).

7. A proxy device for remotely controlling universal plug and play (UPnP) devices in a domain, the proxy device comprising:
a device list unit which stores a list of the UPnP devices;
a list management unit which requests the list of the UPnP devices in the domain and stores the list in the device list unit; and
a UPnP processing unit which generates a search response packet corresponding to the UPnP devices stored in the device list unit when a search for the UPnP devices is remotely requested.

8. The device according to claim 7, wherein the UPnP processing unit comprises:
a packet analyzer which analyzes the search request packet to search for a particular UPnP device;
a list searcher which searches the list of the UPnP devices for the UPnP device analyzed in the packet analyzer; and
a response packet generating unit which generates a search response packet on the basis of the list of the UPnP devices searched in the list searcher.

9. A domain system in which a remote UPnP controller controls universal plug and play (UPnP) devices in a domain, the system comprising:
CP proxy means for transmitting a UPnP packet received from a UPnP device through the Internet and transmitting a received UPnP packet to the UPnP device; and
CD proxy means for transmitting the UPnP packet received from the UPnP controller to the CP proxy means and transmitting the UPnP packet received from the CP proxy means to the UPnP controller,
wherein the CD proxy means stores a UPnP device list received in response to requesting the CP proxy means for the UPnP device list, and when receiving a search request from the UPnP controller, searches the UPnP device list and generates a response packet.
